(19) United States
(12) Patent Application Publication
(10) Pub. No.: US 2018/0092710 A1
(43) Pub. Date: Apr. 5, 2018

(54) ELECTRONIC TOOL RECOGNITION SYSTEM FOR DENTAL DEVICES

(71) Applicant: Kerr Corporation, Orange, CA (US)

(72) Inventors: Matteo R. Bosisio, Lugano (CH); Emanuele Maretto, Placentia, CA (US); Paolo Orsatti, Villa Luganese (CH); Filippo Piffaretti, Giubiasco (CH)

(21) Appl. No.: 15/721,785

(22) Filed: Sep. 30, 2017

Related U.S. Application Data
(60) Provisional application No. 62/402,057, filed on Sep. 30, 2016.

(51) Int. Cl. A61C 1/08; A61C 1/00; A61C 3/02

(52) U.S. Cl. CPC A61C 1/08; A61C 1/02; A61C 3/02; A61C 1/0015

(57) ABSTRACT

A tool for use with an electronic tool recognition system includes a tool blank with a distal tip configured for performing a procedure and a proximal handle encasing, fixedly, a proximal end of the tool blank. A tool-identifying apparatus including a mechanical resonator is embedded in a proximal end of the tool blank to provide a tool identifier. A conductive wire in electrical contact with the resonator provides the identifier to a processor. In another arrangement, conductive brushes in contact with slip rings provide the identifier to a processor. In another arrangement, a dental tool handle includes an insulating portion defining a recess in a proximal end of the handle configured to receive either a sensor or an information-managing chip.

### CROSS REFERENCE TO RELATED APPLICATIONS

This application claims the benefit of U.S. Provisional Patent Application No. 62/402,057 filed Sep. 30, 2016, the entire contents of which are hereby incorporated by reference.

### FIELD OF TECHNOLOGY

Aspects of the disclosure relate generally to dental and/or surgical devices. More specifically, the disclosure relates to a system for recognition of tools used with dental and/or surgical devices.

Endodontic therapy, inclusive of root canal therapy, entails a series of treatments performed on a tooth. The treatments are generally performed on features within the tooth. The tooth may be compromised. The tooth may be structurally compromised and/or infected. The treatments are often directed to precluding onset of infection or to removing infection. The treatments are often directed to protecting the tooth from additional infection. Endodontic therapy may involve removal of nerve and blood tissue from a root canal of the tooth. Endodontic therapy may involve cleaning, shaping, and decontamination of the tooth's root canal and its pulp chambers.

The shape of the formed root canal may be important in facilitating removal of dentinal debris and necrotic tissue. The shape may be important in facilitating irrigation cleaning processes. The shape may facilitate proper flow of gutta-percha (or similarly-purposed substances) and/or sealant during a subsequent obturation phase.

Objectives of root canal therapy may typically include:
a. creating a conical form of the root canal, from an access cavity (coronal) to an apical foramen;
b. preserving the natural curvature of the root canal;
c. avoiding foramen transportation; and
d. keeping the foramen as small as practical.

Generally, a means to achieve these objectives includes a rotary file attached to a contra-angle piece of an endodontic motor. (“Rotary” in this context may include reciprocation, with a file spinning and/or reciprocating, and other motion types such as adaptive motion.) Typically, endodontic rotary devices include a console, a handpiece, a contra-angle piece, and a tool, such as a file (or series of files) to be used in a dental procedure. Other related therapies may require other tools, such as burrs and ultrasound tips, to be affixed to handpieces. Considerations that apply to files may apply as well to these and other endodontal, dental and/or surgical tools. The present invention may be applicable to such other endodontal, dental and/or surgical tools.

A large variety of types of rotary tools are available to a practitioner. The practitioner may use several types in a given procedure. Each type may require a specific set of motions to deliver its optimal performance. In addition, each tool type may be available in several sizes, such that the set of motions needed for a given tool type may require tuning as a function of specific tool size.

Several considerations may contribute to determination of the set of motions. Such considerations may include clinical considerations and other considerations. Clinical considerations may include root canal curvature and calcification. Clinical considerations may include specifics of a planned sequence of therapies to be applied to a given tooth or set of teeth. Other considerations may include device design considerations. For a file, device design considerations may include file cross-section, taper and flute. Device design considerations may include file helix angle, rake angle and pitch. Other considerations may include file material considerations. File material considerations may include file alloy and production-annealing. File material considerations may include file production surface hardening.

Files can withstand limited torsional stress. Beyond a limit of stress, a file may be prone to breakage. File breakage inside a root canal could cause major clinical issues. As a result, rotary devices are typically used at relatively low torque levels. The use of specialized files with differing shapes and sizes also helps avoid file breakage and improves root canal shaping. These files require a corresponding array of different motion settings to enable optimal performance and reliability.

Presently, endodontic motors on the market have several predefined type of motions. Dental health practitioners must manually select an appropriate setting, such as speed and adaptive motion or reciprocating motion, as a function of the type and size of rotary file they intend to use in a root canal procedure. Additionally, a maximum torque delivered by the motor must be manually selected to avoid potential file breakage in the root canal. Within the same procedure, different file sizes and types may be used in succession. The succession may involve many files. The succession may be rapid succession. The time lost in manually setting and resetting specific file motion parameters can be costly in both financial and medical terms. Such lost time may contribute to sub-optimal clinical practice.

If an incorrect motion parameter is set, the file may break inside the tooth. A portion of the file left inside the tooth can create a blockage preventing a complete canal cleaning which can in turn lead to further complications. Human error and avoidance of inconvenience are two additional issues associated with manual selection (calibration) of motion settings to file type.

It would be desirable, therefore, to provide apparatus and methods for a reliable and automatic setting of motion parameters based on the type, inclusive of size, of file inserted into an orthodontal, dental or surgical handpiece.

### SUMMARY OF THE DISCLOSURE

It is an object of this invention to provide apparatus and methods for automatic setting of motion parameters based on the type, inclusive of size, of tool inserted into an orthodontal, dental or surgical handpiece.

### BRIEF DESCRIPTION OF THE DRAWINGS

The objects and advantages of the invention will be apparent upon consideration of the following detailed description, taken in conjunction with the accompanying drawings, in which:

FIG. 1 is a schematic representation of a dental rotary device;

FIG. 2A is a lateral view of a tool handle;

FIG. 2B is a cross-sectional view of the tool handle of FIG. 2A;

FIG. 3 is a schematic representation of a dental tool;

FIG. 4A is a side view of a tool handle;

FIG. 4B is a partial cross-sectional view of the tool handle of FIG. 4A, the view taken along lines 4B-4B (shown in FIG. 4A);

FIG. 4C is a partial cross-sectional view of the tool handle of FIGS. 4A and 4B, the view taken along lines 4C-4C (shown in FIG. 4A);

FIG. 4D is an end view of the tool handle of FIG. 4A;

FIG. 4E is a schematic, partial cross-sectional view of an end of a tool handle;

FIG. 5A is a lateral view of a tool handle;

FIG. 5B is a partial cross-sectional view of the tool handle of FIG. 5A, the view taken along lines 5B-5B (shown in FIG. 5A);

FIG. 5C is an end view of the tool handle of FIGS. 5A and 5B;

FIG. 6A is a perspective view of a tool handle;

FIG. 6B shows a partial cross-sectional view of the tool handle of FIG. 6A, the view taken along lines 6B-6B (shown in FIG. 6C);

FIG. 6C is an end view of the tool handle of FIGS. 6A;

FIG.7 is a perspective view of a contra-angle head, including a cutaway of external features providing a view of internal features of the apparatus;

FIG. 8A is a schematic representation of a tool;

FIG. 8B shows a perspective view of the tool of FIG. 8A;

FIG. 8C shows a perspective view of the tool of FIG. 8A;

FIG. 9A is a block diagram of a tool detection system;

FIG. 9B is a flow chart of one operation of the tool detection system;

FIG. 10 is a schematic representation of another tool;

FIG. 11 is a schematic representation of a tool;

FIG. 12 is a schematic representation of another tool;

FIG. 13 is an exploded partial cross-sectional view of a contra-angle handpiece; and

FIG. 14 is a schematic, cross-sectional view of a contra-angle head connection.

### DETAILED DESCRIPTION OF THE DISCLOSURE

Apparatus and methods for dental procedures are provided. The apparatus may be used to perform one or more steps of the methods. The methods may include methods for manufacture of one or more of the apparatus.

Exemplary embodiments are shown and described below. Features, including structures, materials, volumes, functions and other attributes that are shown and described in connection with any of the embodiments may be combined, in whole or in part, with each other or included, in whole or in part, in other embodiments.

Apparatus and methods described herein are illustrative. Some embodiments may omit steps shown and/or described in connection with the illustrative methods. Some embodiments may include steps that are neither shown nor described in connection with the illustrative methods. Illustrative method steps may be combined. For example, one illustrative method may include steps shown in connection with another illustrative method.

Some apparatus may omit features shown and/or described in connection with illustrative apparatus. Some embodiments may include features that are neither shown nor described in connection with the illustrative methods.

Features of illustrative apparatus may be combined. For example, one illustrative embodiment may include features shown in connection with another illustrative embodiment.

Apparatus may involve some or all of the features of the illustrative apparatus and/or some or all of the steps of the illustrative methods. Methods may involve some or all of the features of the illustrative methods and/or some or all of the steps of the illustrative apparatus.

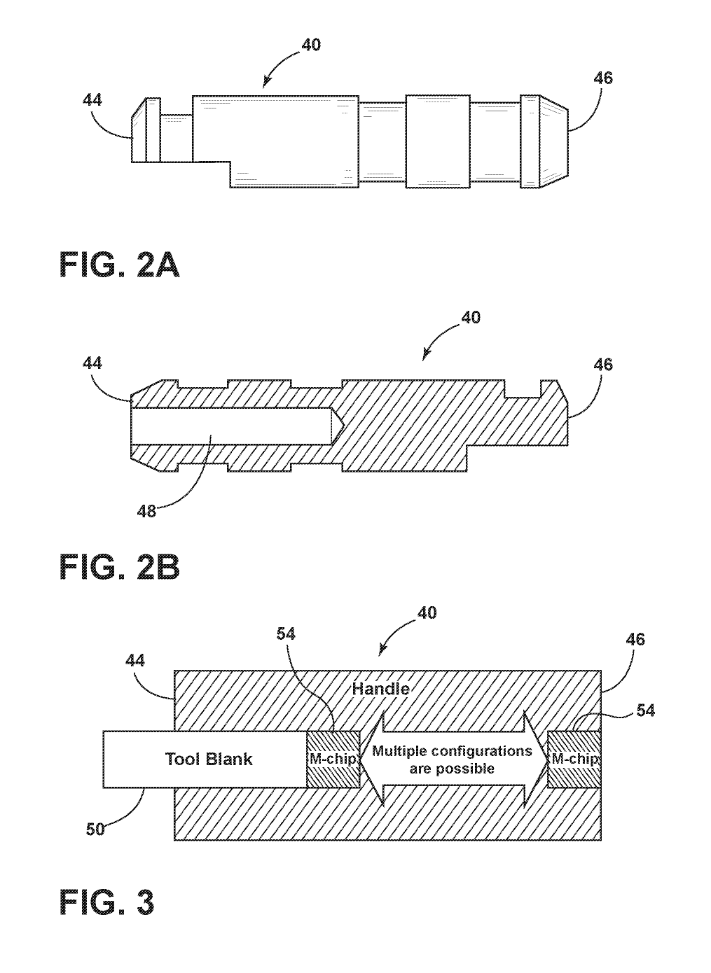

The apparatus may include, and the methods may involve, apparatus and methods for detecting a dental tool-type of a dental tool. The dental tool may include a tool handle (see, e.g., FIGS. 2A and 2B). The dental tool may include a file tip. The tool may include a one or more unique tool identifiers (see, e.g., “M-chip” in FIG. 3). The file may include one or more unique file identifiers. The file may include one or more device communications bus systems. The one or more device communications bus systems may include the identifier(s). The identifier(s) may include one or more contact identifier tag(s). The identifier(s) may include MAXIM™ 1-WIRE™ technology. Alternatively and/or additionally, the bus system(s) may include one or more other suitable technologies. The one or more other suitable technologies may include I²C™ technology. The identifier(s) may include non-contact identifier tag(s). The identifier(s) may include radio-frequency identification (RFID) technology.

The apparatus may include, and the methods may involve, one or more dental rotary systems. The apparatus may include, and the methods may involve, one or more dental non-rotary systems. The system(s) may include one or more handpiece(s). The system(s) may include one or more contra-angle device(s). The system(s) may include one or more consoles. The system(s) may include one or more tools. The tool(s) may include the file. The tool(s) may include one or more consumable drilling tools. The tool(s) may include one or more consumable filling tools. The tool(s) may include one or more consumable prophylaxis tools. The tool(s) may include one or more consumable scaling tools. The tool(s) may include one or more disposable drilling tools. The tool(s) may include one or more disposable filling tools. The tool(s) may include one or more disposable prophylaxis tools. The tool(s) may include one or more disposable scaling tools. The tool(s) may include one or more replaceable drilling tools. The tool(s) may include one or more replaceable filling tools. The tool(s) may include one or more replaceable prophylaxis tools. The tool(s) may include one or more replaceable scaling tools. The handpiece(s) may include the contra-angle device(s). The contra-angle device(s) may be attached to the handpiece(s). The contra-angle device(s) may be integral to the handpiece(s). The handpiece(s) may include one or more devices other than contra-angle devices.

The system may include one or more connections between the handpiece(s) and a console. The system may include one or more connections between the contra-angle device(s) and the console. The system may include one or more connections between the tool and the console. The system may include one or more connections between one or more tools and the console. The tool(s) may include file(s).

The connection(s) may include a tethered connection. The one or more connections may include a physical connection. The connection(s) may include a cable. The cable may include a USB cable. The connection(s) may be wireless. The connection(s) may include a wireless local access network. The connections may include a Wi-Fi® connection. The connections may include a BLUETOOTH™ connection. The console may be connected to a power source or battery powered.

The handpiece may be connected to the tool. The tool may be inserted into the handpiece. The tool may be snapped into the handpiece. The tool may be inserted into the contra-angle device. The tool may be snapped into the contra-angle device. The tool may be scanned by the console or handpiece either before or after being inserted or snapped into the contra-angle. The tool may be scanned by the console or the handpiece when still in the tool's packaging. The tool may be replaceable. The tool may include the file. The file may include a spinning file. The tool may include a series of files.

The tool may be used in a dental procedure. The procedure may include a prophylaxis procedure. The procedure may include an endodontic procedure.

The handpiece may include one or more memories. The one or more memories may be embedded in the handpiece. The console may include the one or more memories. The one or more memories may be embedded in the console. The one or more memories may include one or more look-up tables. The look-up table(s) may be updated. The look-up tables may be look-up tables of one or more tool-identifiers. The look-up tables may be look-up tables of one or more tool-identifiers. The one or more memories may include data relating to one or more motion parameters.

The handpiece may recognize the tool when the tool is inserted into the handpiece. The handpiece may recognize the tool as the tool is inserted into the handpiece. The handpiece may recognize the tool after the tool is inserted into the handpiece. The handpiece may recognize the tool before the tool is inserted into the handpiece. Such recognition may be performed using the look-up table. The recognition may be performed using an identification scanner.

The one or more memories may record the tool identifier(s). The one or more memories may record the file identifier(s). The one or more memories may record one or more tool usage conditions. The one or more memories may record one or more tool usage parameters. The one or more memories may contain results of measuring and/or calculating one or more tool variables. The variable(s) may relate to performance. The variable(s) may relate to endurance. The variable(s) may relate to durability. The variable(s) may relate to errors. The variable(s) may relate to error-rates. The variable(s) may relate to useful/safe life left in the tool. The one or more memories may include data related to tool expiry. The variable(s) may relate to other properties of the tool(s), as known to one skilled in the art.

The console may download the usage condition(s) from the handpiece. The console may download the usage parameter(s) from the handpiece. The console may download the variable(s) from the handpiece. The console may download the tool identifier(s) from the handpiece. The console may download any relevant data from the handpiece. The console may be connected to the internet for updates. The handpiece may be connected to the internet for updates. The console may be connected to the cloud for updates. The handpiece may be connected to the cloud for updates. The handpiece may perform data acquisition, data recording, data storage and/or data processing independent of the console. The handpiece may perform data acquisition, data recording, data storage, data transmission and/or data processing in conjunction with the console.

The methods may include detecting an impedance associated with the contra-angle device. The method may include calculating an impedance associated with the contra-angle device. The method may include detecting a contra-angle device impedance. The method may include calculating a contra-angle device impedance.

The method may include detecting an impedance associated with the handpiece. The method may include calculating an impedance associated with the handpiece. The method may include detecting a handpiece impedance. The method may include calculating a handpiece impedance.

The method may include attaching the file to the contra-angle device. The method may include assembling the file with the contra-angle device. The method may include inserting the file into the contra-angle device.

The method may include attaching the file to the handpiece. The method may include assembling the file with the handpiece. The method may include inserting the file into the handpiece.

The method may include determining a total impedance. The determination may be performed using an impedance analyzer. The impedance analyzer may be a digital impedance analyzer. The impedance analyzer may be a spectral impedance analyzer. The impedance analyzer may digitize data. The impedance analyzer may compute a Fast Fourier Transform (FFT) of the impedance data.

The total impedance may include the impedance associated with the contra-angle device summed with a tool impedance. The total impedance may include the impedance associated with the handpiece summed with a tool impedance. In one embodiment, the tool is a file.

The method may include computing the file impedance by subtracting the impedance associated with the contra-angle device from the total impedance. The method may include computing the file impedance by subtracting the impedance associated with the handpiece from the total impedance. The subtracting may include subtracting a FFT signal of the total impedance and a FFT signal of the impedance associated with the contra-angle device, thereby calculating a spectral signature of the file. The subtracting may include subtracting a FFT signal of the total impedance and a FFT signal of the impedance associated with the handpiece, thereby calculating a spectral signature of the file.

System working frequencies may be adjusted to match frequencies required by obtaining one or more apex measurements. The apex measurement(s) may be of a root canal depth. System working frequencies may be adjusted to match frequencies required by obtaining meaningful spectral signatures of specific tools, including files. The computing may be performed in a controller unit. The computing may be performed in the console. The computing may be performed in the handpiece. The computing may be performed in a processor.

The file may include one or more design optimizations enabling specific spectral signatures that may identify the file. File design optimization(s) may include one or more optimized handle material(s). File design optimization(s) may include one or more coating(s). File design optimization(s) may include one or more optimized handle shape(s). File design optimization(s) may include one or more resonator(s). The resonator(s) may have specific resonant frequencies within a desired bandwidth. The resonator(s) may display specific peak resonant frequencies. The resonator(s) may act as a stopband. The resonator(s) may act as any other filter.

The method may include recognizing the tool-type based on the tool impedance. The method may include determining the file-type based on the file impedance.

The method may include setting a corresponding configuration of parameters for the tool. The method may include adjusting a corresponding configuration of parameters for the tool. The method may include setting a corresponding configuration of motion parameters for the tool. The method may include adjusting a corresponding configuration of motion parameters for the tool. In one embodiment, the tool is a file.

The method may include setting a corresponding configuration of parameters for the file based on the determined file impedance. The method may include adjusting a corresponding configuration of parameters for the file based on the determined file impedance. The method may include setting a corresponding configuration of motion parameters for the file based on the determined file impedance. The method may include adjusting a corresponding configuration of motion parameters for the file based on the determined file impedance.

The apparatus may include, and the methods may involve, an electronically-recognizable endodontic rotary tool. The rotary tool may be configured for insertion into a dental handpiece. The rotary tool may be configured for performing a dental procedure. The tool may include a tool blank. The tool blank may include a distal tip. The distal tip may be configured for close proximity to a tooth's exterior and/or interior during the dental procedure. In another embodiment, the rotary tool is a rotary file having a file blank with a distal tip.

The file may include a proximal handle. The file blank may be associated with a proximal handle. The proximal handle may encase a proximal end of the file blank. The proximal handle may fixedly encase a proximal end of the file blank. The proximal handle may be associated with the file blank.

The tool may include a tool-identifying apparatus. The tool-identifying apparatus may include a resonator. The resonator may include a mechanical resonator. The mechanical resonator may include a Langevin resonator. The mechanical resonator may include a crystal resonator. The mechanical resonator may include a piezoelectric material. The piezoelectric material may include quartz. The resonator may include an electrical resonator. The electrical resonator may include an inductance (L) circuit. The electrical resonator may include an inductance-capacitance (LC) circuit. The electrical resonator may include an inductance-capacitance-resistance (LCR) circuit. The resonator may be embedded in the tool blank. The resonator may be embedded in the proximal end of the file tool. The resonator may be added into a core of the handle. The resonator may be added inside the handle during a tool assembling. The resonator may provide a tool identifier.

The tool may include an insulating element. The insulating element may encase a portion of the proximal end of the tool blank.

The tool may include a conductive element. The conductive element may include a wire. The conductive element may be in electrical contact with the resonator. The conductive element may be configured to transmit the tool identifier from the resonator. The conductive element may be configured to transmit the tool identifier through the handpiece. The conductive element may be configured to transmit the tool identifier to a processor. The conductive element may be configured to perform a transmission of the tool identifier to identify the tool. The transmission may occur after the tool is inserted into a distal end of the handpiece.

The apparatus may include, and the methods may involve, a dental handpiece for performing a dental procedure. The handpiece may include a housing. The handpiece may include a rotary assembly. The rotary assembly may be cylindrical. The rotary assembly may be positioned within the housing. The rotary assembly may hold the tool handle therewithin.

The handpiece may include a rotary assembly gear. The rotary assembly gear may be fixed to the rotary assembly. The rotary assembly gear may be fixed to the rotary assembly on an external surface thereof. The rotary assembly gear may surround the rotary assembly on an external surface thereof. The rotary assembly gear may be in mechanical contact with a drive gear.

The handpiece may include one or more slip rings. The slip ring(s) may be conductive. The slip ring(s) may be fixed to the rotary assembly. The slip ring(s) may surround the rotary assembly on an external surface thereof.

The handpiece may include one or more brushes. The brush(es) may be conductive. The brush(es) may be in contact with the one or more slip rings.

The handpiece may include one or more contacts. The contact(s) may be positioned at a proximal end of the file handle. The contact(s) may transmit one or more specific signals. The contact(s) may transmit one or more specific file identifiers.

The handpiece may include one or more sensors. The brush(es) may transmit data from the sensor(s) to a processor. The contact(s) may transmit data from the sensor(s) to the processor.

The apparatus may include, and the methods may involve, a dental tool handle. The dental tool handle may manage information during a dental procedure. The dental tool handle may collect information during the dental procedure. The dental tool handle may receive information during the dental procedure. The dental tool handle may record information during the dental procedure. The dental tool handle may store information during the dental procedure. The dental tool handle may process information during the dental procedure. The dental tool handle may transmit information during the dental procedure. The dental tool handle may include an information-managing chip.

The dental tool handle may be in communication with other tools used in a dental office. The dental tool handle may be in communication with other electronic components of a dental practice. The dental tool handle may be in communication with other components of a dental treatment unit. Data from the dental tool handle may include data corresponding to maintenance and/or usage status of the dental tool handle. Such data may inform other components of the dental practice as to maintenance requirements of the dental tool handle. The maintenance and/or usage status data may include predictive and/or pre-emptive care of the dental file handle. The maintenance and/or usage status data may indicate an upcoming need for a battery recharge cycle for the dental tool handle. The maintenance and/or usage status data may indicate an oiling and/or other maintenance protocol for the dental tool handle. An indication of the oiling protocol may be processed by an oiling machine. The indication of the oiling protocol may prepare the oiling machine for the dental tool handle.

The maintenance and/or usage status data may correspond to a state of sterilization of the dental tool handle. Such state of sterilization data may include a date of a previous sterilizing process of the dental tool handle. Such state of sterilization data may include information about previous sterilizing processes and/or reflect the current sterilization state of the dental tool handle. An indication of the sterilization status may include indication of a sterilizing protocol. The indication of the sterilizing protocol may be processed by sterilizing equipment. The indication of the sterilizing protocol may prepare the sterilizing equipment for the dental tool handle.

The dental tool handle may be a dental file handle that includes a file handle body with a proximal end and a distal end. The file handle body may be cylindrical. The file handle body may be hollow. The file handle body may include a metallic material. The metallic material may include brass. The metallic material may include nickel. The metallic material may include steel. The steel may include stainless steel. The metallic material may include titanium. The metallic material may include a metal alloy. The file handle body may include a polymer. The file handle body may include plastic.

The dental tool handle may include a wire. The wire may be insulated. The wire may extend within the handle body from the proximal end.

The dental tool handle may include a sensor. The sensor may include a printed circuit board. The circuit board may be attached to a distal end of the wire. The circuit board may face a recess within the handle. The recess may receive a file tip.

The dental tool handle may include a proximal conductive element. The proximal conductive element may include a glue. The glue may have a shape of a sphere. The glue may have a shape of part of a sphere. The glue may have the shape of a ball. The glue may have the shape of part of a ball. The glue may have any suitable shape. Any suitable shape may include the glue being flat. The glue may include a metallic cement. The glue may include a conductive cement. The glue may be conductive. The glue may conduct electronic data from the wire. The glue may conduct electronic data to a processor.

The handle may feature external contours complementary to internal contours of an assembly configured to engage the handle. The handle may include geometric surface features. The geometric surface features may be present at the proximal end of the tool handle body. The geometric surface features may be external. The geometric surface features may mechanically engage corresponding internal features of a rotary assembly. The rotary assembly may be specialized. The rotary assembly may be specialized to engage only specific tool handle geometric surface features.

The tool handle may include an insulating layer. The insulating layer may include a lacquer. The insulating layer may prevent electrical conductivity between the glue and the tool handle body.

The apparatus may include, and the methods may involve, a dental tool handle. The dental tool handle may serve to collect information during a dental procedure. The dental tool handle may collect information during the dental procedure. The dental tool handle may manage information during the dental procedure. The information may relate to the dental procedure. The information may relate to physical parameters of the file. The information may relate to physical parameters of the tool during the dental procedure. The tool handle may include an electrically insulating, proximal portion. The proximal portion may define a first recess in a proximal end. The first recess may be configured for receiving a sensor. The electrically insulating, proximal portion may include a rigid material. The electrically insulating, proximal portion may include a plastic material. The electrically insulating, proximal portion may include a ceramic material.

The tool handle may include an electrically conductive distal portion. The distal portion may define a second recess in a distal end. The second recess may be configured for receiving a proximal end of a file tip. The electrically conductive distal portion may include a metallic material. The metallic material may include brass. The metallic material may include nickel. The metallic material may include gold. The metallic material may include steel.

The electrically insulating, proximal portion may be embedded within the electrically conductive distal portion. The electrically insulating, proximal portion may encase the electrically conductive distal portion.

The proximal portion may include a proximal end. The proximal end of the proximal portion may include one or more geometries configured for mechanical engagement with corresponding features of a rotary assembly. The proximal portion proximal end geometries may be on an external surface of the proximal end. The corresponding rotary assembly features may be on an internal surface of the rotary assembly. The rotary assembly may be a specialized rotary assembly.

The apparatus may include, and the methods may involve, a dental tool handle. The dental tool handle may serve to collect information during a dental procedure. The dental tool handle may collect information during the dental procedure. The information may relate to the dental procedure. The information may relate to physical parameters of the tool during the dental procedure. The dental tool handle may include a cylindrical body. The cylindrical body may include an electrically conductive material. The electrically conductive material may include a metallic material. The metallic material may include brass. The metallic material may include nickel. The metallic material may include steel.

The body may define a proximal recess. The proximal recess may be defined in a proximal end. The proximal recess may be configured for receiving a sensor.

The body may define a distal recess. The distal recess may be defined in a distal end. The distal recess may be configured for receiving a proximal end of a file tip.

The proximal end may include one or more geometries configured for mechanical engagement with corresponding features of a rotary assembly. The geometries may be on an external surface of the proximal end. The corresponding features may be on an internal surface of the rotary assembly. The rotary assembly may be a specialized rotary assembly.

The tool handle may include an electrically insulating material. The electrically insulating material may be positioned within the proximal recess. The electrically insulating material may shield the sensor from the electrically conductive material. The electrically insulating material may include a resin. The electrically insulating material may include a lacquer. The electrically insulating material may include a plastic. The electrically insulating material may include a ceramic. The electrically insulating material may include a rubber. The electrically insulating material may include a natural material. The electrically insulating material may include a synthetic material.

The apparatus may include, and the methods may involve, a dental tool handle. The dental tool handle may collect information during a dental procedure. The tool handle may include a tool handle body. The tool handle body may receive at its distal end a proximal end of a tool blank.

The tool handle may include a tool-identifying device. The tool-identifying device may be positioned within the tool handle. The tool-identifying device may be positioned proximal to a distal end of the tool blank. The tool identifying device may include an RFID tag. The tool identifying device may include an RFID chip.

The tool handle may include one or more sensors. The sensor(s) may include an accelerometer. The sensor(s) may include a GPS device. The sensor(s) may include one or more motion sensors. The sensor(s) may include one or more temperature sensors. The sensor(s) may include one or more pressure sensors. The sensor(s) may include one or more load sensors. The sensor(s) may include one or more torque sensors. The sensor(s) may include one or more error-state detectors. The sensor(s) may include one or more counters. The sensors may include solid-state electronics. The sensors may include liquids. The liquids may be liquid metals.

The tool may include one or more microchips. The file may include the microchip(s). The file handle may include the microchip(s). The tool may include one or more integrated circuit(s). The file may include the integrated circuit(s). The file handle may include the integrated circuit(s). The microchip(s) may be suitably sized to fit on and/or in a dental file handle. The integrated circuits(s) may be suitably sized to fit on and/or in a dental file handle. The tool may include a communication bus. The bus may use a serial protocol. The protocol may use a single data line. The protocol may use a single data line plus ground. The microchip(s) may include MAXIM™ 1-WIRE™ technology. The microchip(s) may include one or more injection-molded thermoplastic parts with integrated electronic circuit traces. The microchip(s) may be included in a file system with one or more molded interconnect devices (MIDs).

The apparatus may include, and the methods may involve, preassembling to the tool one or more microchips. The preassembling may include selective metallization of thermoplastic injection molded parts by laser direct structuring (LDS). The metallization may facilitate electrical contact integrating the microchip and any performing wire(s). The preassembling may include liquid crystal polymers. The preassembling may include VECTRA™ technology. Such metal-to-plastic preassembly methods may be used with plastic file handle bodies to integrate electrical elements directly onto/into the plastic. Such plastic tool handle bodies may be made largely or entirely of plastic. Such plastic tool handle bodies may be made electrically integrateable with the device by LDS. Such plastic tool handle bodies may be made electrically integrateable with the device by other assembly methods.

Apparatus and methods in accordance with the invention will now be described in connection with the Figs., which form a part hereof. The Figs. show illustrative features of apparatus and/or methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown and described herein. Some embodiments may omit steps shown and described in connection with the illustrative methods. Some embodiments may include steps that are not shown and/or not described in connection with the illustrative methods. Illustrative method steps may be combined. For example, one illustrative method may include steps shown in connection with another illustrative method.

The apparatus and methods of the invention will be described in connection with embodiments and features of illustrative devices. It is to be understood that other embodiments may be utilized and that structural, functional and procedural modifications may be made without departing from the scope and spirit of the present invention.

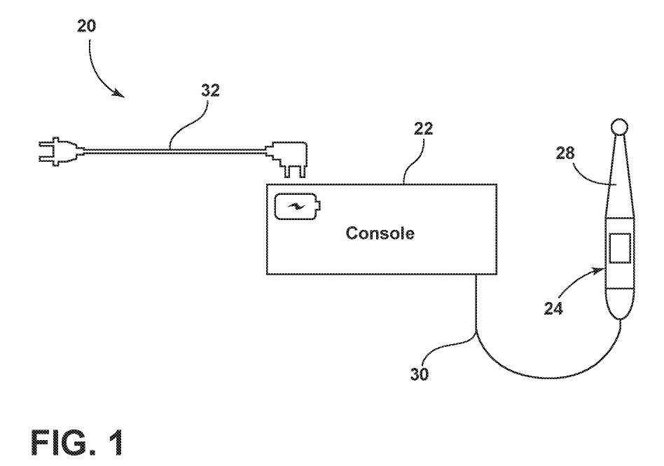

FIG. 1 depicts a dental rotary device 20 comprising a console 22 and a handpiece 24 including a contra-angle portion 28. The handpiece 24 is typically connected at one end to the console 22 by a cable 30, which is in turn wired to a power outlet by a power connector 32. Alternatively and/or additionally, the handpiece 24 may communicate wirelessly with console 22. The handpiece 24 may be battery-powered in place of the cable 30. The handpiece 24 may be connected at its other end to a replaceable tool, such as a spinning file or, over a course of a dental procedure such as endodontic therapy or a prophylaxis, a series of tools including files. In some embodiments, the dental rotary device 20 is a contra-angle device.

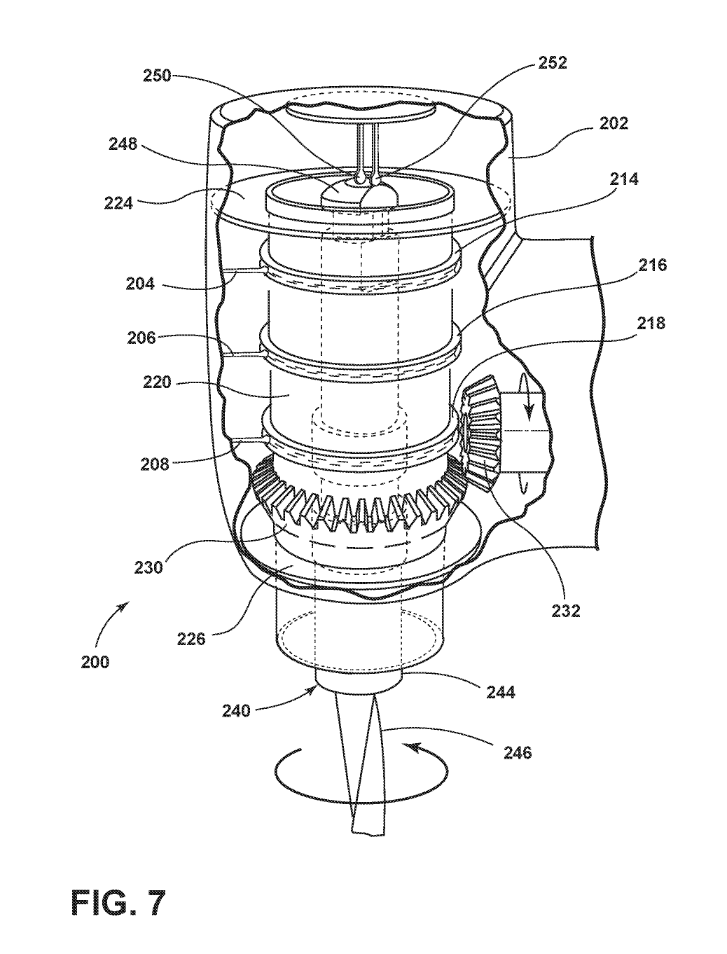

FIG. 2A shows a lateral view of another embodiment of a tool handle 40 specialized to collect sensor data during a dental procedure. The tool handle body is generally cylindrical with a recess (not shown) at its distal end 44 for receiving the proximal end of a tool tip. The proximal end 46 of the tool handle 40 includes external geometric surface features for mechanically engaging corresponding to internal features of a specialized rotary assembly configured to engage the tool tip. (See, e.g., FIG. 7 for an illustrative rotary assembly.) In one embodiment, the tool handle 40 is a file handle for receiving a file tip.

FIG. 2B shows a lateral cross-sectional view of the tool handle 40 shown in FIG. 2A. The tool handle body is generally cylindrical with a recess 48 at its distal end 44 for receiving the proximal end of a tool tip. The proximal end 46 includes external geometric surface features for mechanically engaging corresponding internal features of a specialized rotary assembly.

FIG. 3 schematically illustrates a principle of one embodiment. A tool handle 40 receives at a distal end 44 the proximal end of a tool blank 50. A file identifying device 54, such as an appropriately-sized RFID chip (for example, the “μ-chip™” manufactured by Hitachi™ Ltd.) may be associated with any one of several positions within or upon the tool handle 40.

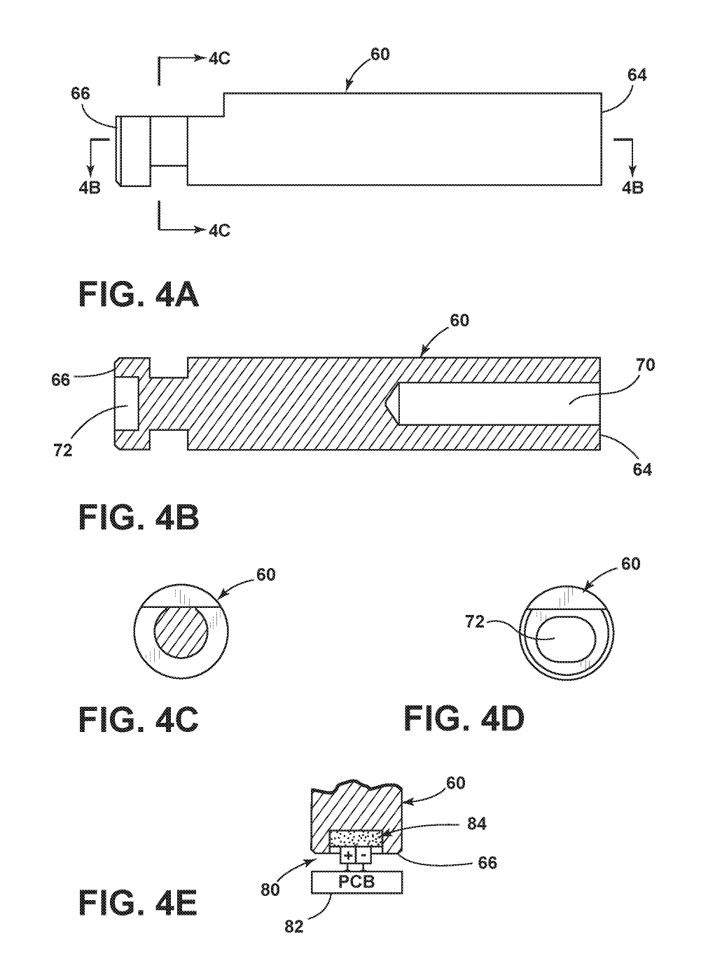

FIG. 4A shows a lateral view of an embodiment comprising a tool handle 60 specialized to report data for a dental procedure. The tool handle body may be generally cylindrical with a recess (not shown) at its distal end 64 for receiving the proximal end of a tool tip. Another smaller recess (not shown) at its proximal end 66 may be configured to receive a specialized sensor. The proximal end 66 may include external geometric surface features for mechanically engaging corresponding internal features of a specialized rotary assembly (not shown). The tool handle body may be formed of a solid piece of suitable rigid material, such as brass, stainless steel, NiTi or other materials.

FIG. 4B shows a cross-sectional view of the tool handle 60 taken along lines 4B-4B (shown in FIG. 4A). The tool handle body may be generally cylindrical with a recess 70 at its distal end 64 for receiving the proximal end of a tool tip. Another smaller recess 72 at its proximal end 66 may be configured to receive a microchip.

FIG. 4C shows a cross-sectional view of the tool handle 60 taken along lines 4C-4C (shown in FIG. 4A; viewed along a longitudinal axis facing distally toward the proximal end 66). The proximal end 66 includes external geometric surface features for mechanically engaging corresponding internal features of the rotary assembly.

FIG. 4D shows the tool handle 60 shown in FIG. 4A as viewed facing the proximal end 66. The recess 72 at the proximal end 66 is configured to receive a specialized sensor. The proximal end 66 also includes external geometric surface features for mechanically engaging corresponding internal features of a specialized rotary assembly.

FIG. 4E shows the proximal end 60 of the metal tool handle 60 of FIGS. 4A-4D, with a sensor 80 embedded within the recess 72. The sensor 80 may include a printed circuit board 82. The sensor 80 may be insulated from electrically conductive surfaces of the tool handle body by an electrically insulating resin layer sandwiched between the sensor components and the conductive body material of the tool handle 60.

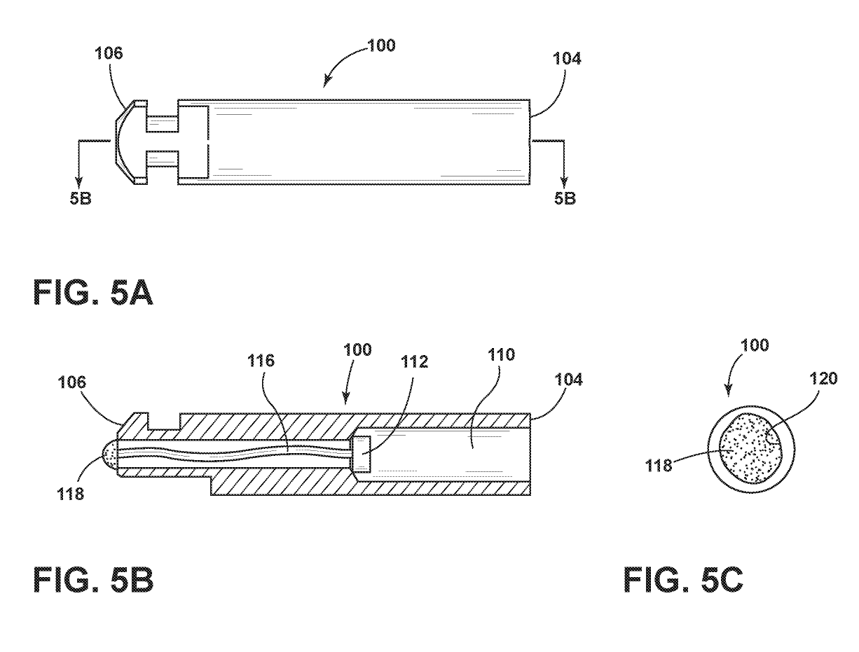

FIG. 5A shows a lateral view of an embodiment of a hollow, cylindrical dental tool handle 100 that may include one or more embedded microchips. The microchip(s) may include one or more sensors. The microchip(s) may include an identifier. The identifier may be a unique identifier. The identifier may make use of MAXIM™ 1-WIRE™ technology. A distal end 104 of the tool handle 100 includes a recess or bore hole. A proximal end 106 of the tool handle 100 may include external geometric surface features for mechanically engaging corresponding internal features of a specialized rotary assembly. The microchip(s) may be positioned on any internal or external surface of the tool handle 100. The microchip(s) may be positioned on any internal or external surface of the tool received by the tool handle 100.

FIG. 5B shows a cross-sectional view of the tool handle 100 of FIG. 5A. FIG. 5B shows a recess 110 at the distal end 104 of the tool handle 100 for receiving a proximal end of a tool tip. The tool handle 100 may include one or more printed circuit boards (PCBs) 112. The tool handle 100 may include a grounding pin integral with, and/or connected, soldered or glued to, an inner surface of the tool handle 100. The tool handle 100 may include one or more insulated wires 116 for transmitting data to one or more processors. Wires and ground connection may be via conductive glue 118 disposed at the proximal end 106 of the tool handle 100 or on handle inner surfaces which may be insulated from the tool handle by an insulating layer. The layer may include a lacquer. The conductive glue 118 disposed in the proximal end may be formed in a roughly spherical shape or round shape. The conductive glue 118 in the proximal end may be formed to lie flat.

The PCB 118 may include the microchip. The microchip may include MAXIM™ EEPROM technology. The tool handle 100 may include an analog tool identifier. The tool identifier may include one or more L/LC/LCR circuits for analog tool recognition. The tool handle may include a digital tool identifier that uses MAXIM™ 1-WIRE™ technology.

FIG. 5C shows a view of the proximal end 106 of the tool handle 100 of FIGS. 5A and 5B, including the insulating layer 120 for avoiding conductive contact with the external layer of the tool handle.

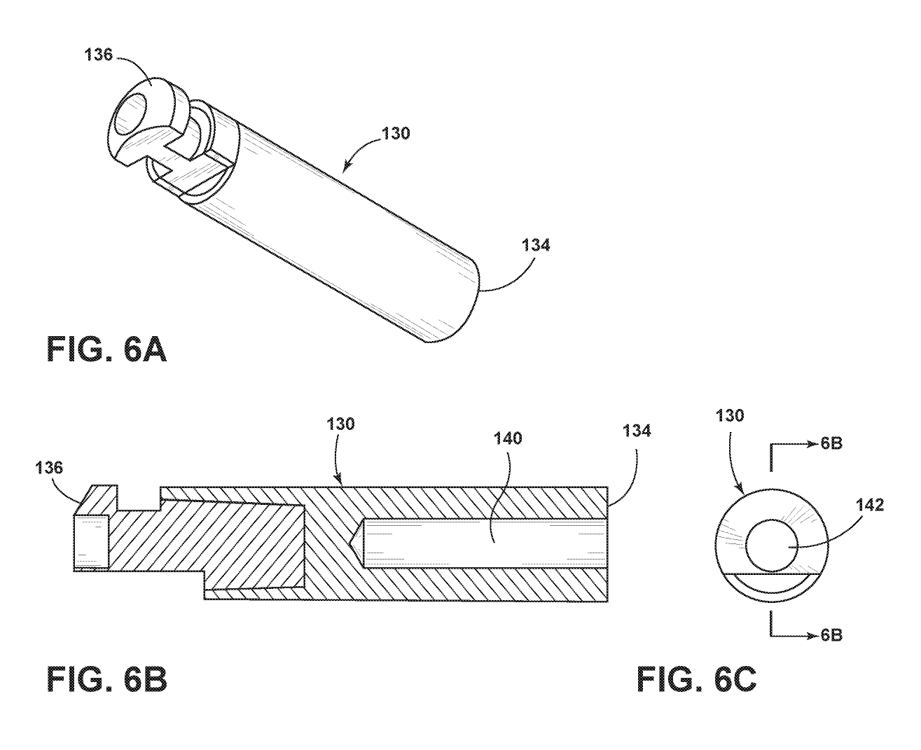

FIG. 6A shows a perspective view of another embodiment of a tool handle 130 with unique file identification capabilities. The tool handle 130 has a distal end 134 that receives a tool tip and a proximal end 136. The tool handle 130 may include one or more printed circuit boards (PCBs) that may include one or more microchips. The microchip(s) may include one or more sensors. The microchip(s) may include an identifier. The identifier may be a unique identifier. The identifier may make use of MAXIM™ 1-WIRE™ technology. The tool handle 130 may include features for collecting sensor data during a dental procedure. The tool handle body is generally cylindrical with a recess 140 at its distal end 134for receiving the proximal end of a tool tip. Another smaller recess at the proximal end 136 of the tool handle 130 is configured to receive a specialized sensor. The proximal end 136 includes external geometric surface features for mechanically engaging corresponding internal features of a specialized rotary assembly. A proximal portion including the proximal end may be formed of an electrical insulator, such as plastic, which may be fused within the distal portion that may include an electrically conductive material, such as brass. The proximal end may include the microchip(s). The microchip(s) may be included into one or more injection-molded thermoplastic parts with integrated electronic circuit traces. The microchip(s) may include one or more molded interconnect devices (MIDs).

The proximal end of the tool handle 130 may be preassembled with the microchip(s). The proximal end 136 may then be mounted on the rotary assembly. The proximal end may include plastic. The proximal end 136 may include selective metallization of thermoplastic injection molded parts by laser direct structuring (LDS). The proximal end may include liquid crystal polymers. The proximal end may include VECTRA™ technology. The preassembly may provide for microchip integration without compromise of handle torque tolerance, the latter conferred by the metal (brass, steel, etc.) of the handle distal part toward the distal end 134 of the tool handle 130.

FIG. 6B shows a cross-sectional view of the tool handle 130 of FIG. 6A. The tool handle body may be generally cylindrical with the recess 140 at its distal end 134 for receiving the proximal end of a file tip.

FIG. 6C shows a view of the proximal end 136 of the tool handle 130 of FIGS. 6A and 6B. A central recess 142 within the proximal tip of the tool handle 130 may be configured to receive a microchip or a sensor. External geometric surface features may be configured for mechanical engagement with corresponding internal features of the rotary assembly.

FIG. 7 shows an embodiment of a contra-angle head 200 with a cutaway view through the contra-angle head housing 202 revealing internal parts including a specialized system of tool recognition components and other specialized sensor components. These components include one or more electro-conductive brushes 204, 206, 208 in contact with one or more respective slip rings 214, 216, 218 on an external surface of a rotary assembly 220. The contra-angle head 200 includes an upper membrane seal 224 and a lower membrane seal 226. Further, the rotary assembly 220 includes a rotary assembly gear 230 that is driven by a drive gear 232 of the contra-angle head 200. The rotary assembly 220 secures within its interior a tool handle of a dental tool 240. The dental tool 240 includes a shank portion 244, a flute portion 246, and a proximal tool handle top 248. One or more internal sensors (not shown) may generate signals corresponding to properties of the file, such as motion, temperature, and/or rotational or axial load or force (e.g., via piezoelectric sensor(s) or strain gauge[s]), and transmit those signals to a processor via the brushes. Additionally, or alternatively, one or more contacts 250, 252 disposed at a proximal end of the rotary assembly 220 detect a unique identifier embedded on the proximal tool handle top 248 and transmit the identifier to the processor.

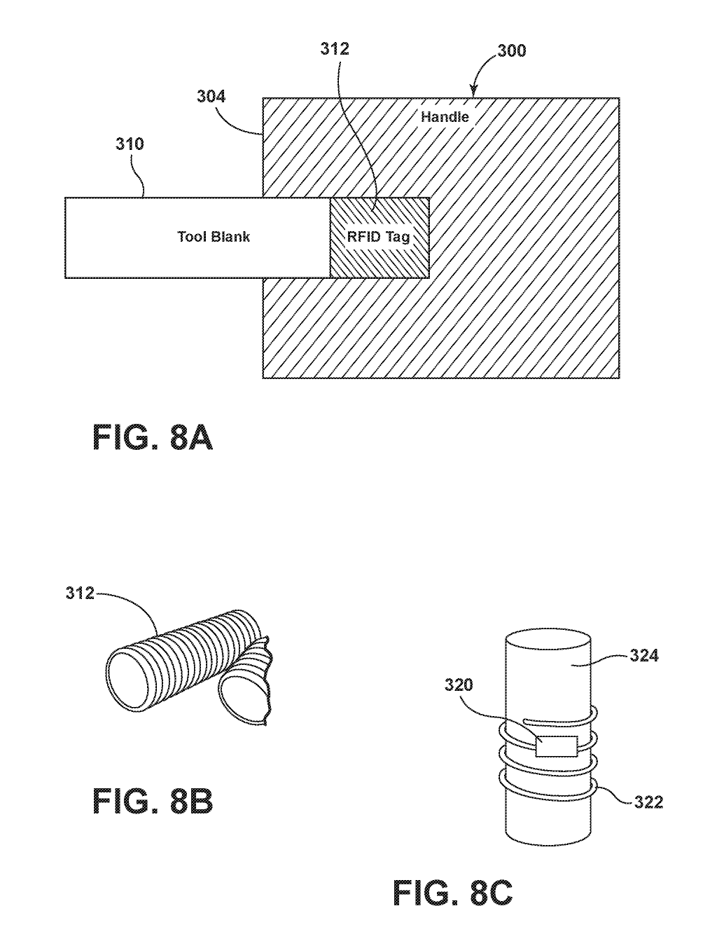

FIG. 8A is a schematic diagram of another embodiment of a tool handle 300. The tool handle 300 receives at a distal end 304 the proximal end of a tool blank 310. A file identifying device, such as an appropriately-sized RFID tag 312 is positioned within the tool handle 300 proximal to a distal end of the tool blank 310.

FIG. 8B shows a perspective view of an appropriately-sized RFID tag 312 with a built-in antenna boost that may be positioned within a dental tool handle for detection and processing by a dental file-recognition system.

FIG. 8C shows a perspective view of an appropriately-sized microchip 320 connected to an antenna boost 322 coiled around a PMMA-like block 324. The microchip 320 may be positioned within a dental tool handle for detection and processing by a dental file-recognition system.

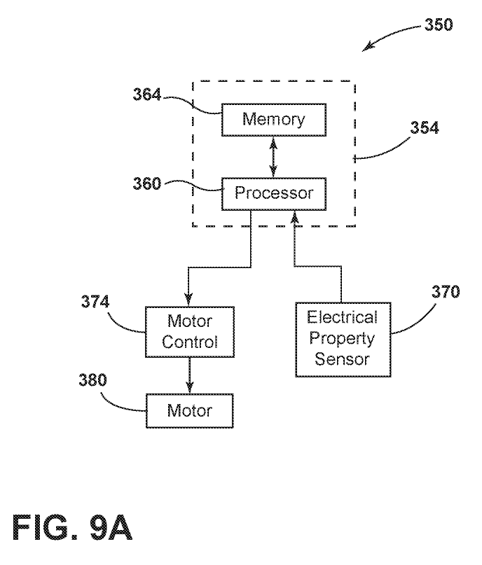

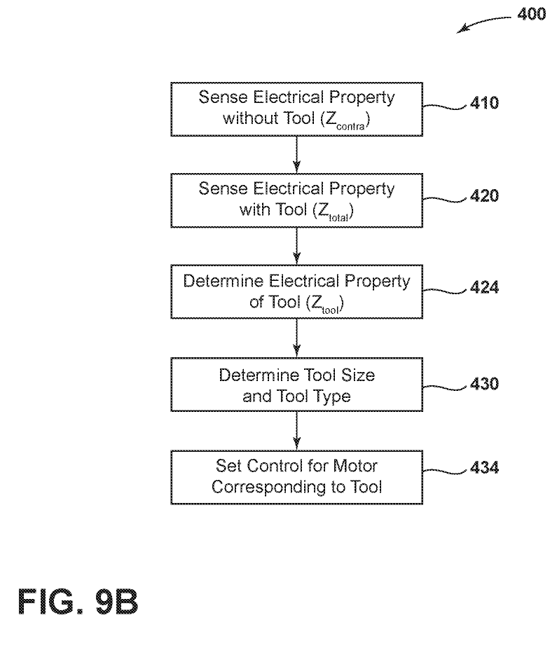

FIG. 9A schematically shows a tool detecting system 350 for detecting a tool, such as an endodontic rotary file, by making use of the natural or artificially manipulated impedance of the tool. The tool detecting or recognition system 350 shown in FIG. 9A includes a controller 354 that has a processor 360 and a memory 364. The tool detecting system 350 includes an electrical property sensor 370 and a motor control 374. The motor control 374 controls the operation of a motor 380 for powering a tool secured to the contra-angle device.

In some embodiments, the electronic processor 360 is a microprocessor, an application-specific integrated circuit (“ASIC”), or other suitable electronic processing device provided with the memory 364. In some embodiments, the memory 364 is a non-transitory computer-readable medium including random access memory (“RAM”), read-only memory (“ROM”), or other suitable non-transitory computer-readable medium. Other types of memory 364 and circuitry are contemplated.

The electrical property sensor 370 includes one or more sensors disposed on the contra-angle device from a group consisting of: an impedance sensor, an inductance sensor, a capacitance sensor, and a resistance sensor. In one embodiment, the electrical property sensor 370 is a digital impedance analyzer for obtaining digital impedance values.

FIG. 9B shows a flow chart 400 for one operation of the tool detecting system 350 shown in FIG. 9A. In operation, the electrical property sensor 370 senses a value (Z_{contra}) of an electrical property associated with the contra-angle device without the tool attached to the contra-angle device (step 410). The sensed electrical value is provided to the processor 360. A user then attaches a tool to the contra-angle device. The electrical property sensor 370 then provides a total value (Zₜₒₜₐₗ) of an electrical property of the contra-angle device with the tool attached to the processor 360 (step 420). The processor 360 then calculates a tool impedance (Zₜₒₒₗ) by subtracting from a total detected impedance (Zₜₒₜₐₗ) the previously calculated impedance (Z_{contra}) of the contra-angle device into which the tool is inserted (step 424). Using the calculated tool impedance (Zₜₒₒₗ), the tool size and type are then detected/determined (step 430). Thereafter, motion parameters or settings, and other operational settings are calibrated or set, for control of a motor of the contra-angle device that drives the tool (step 434). Thus, in the particular example shown in FIG. 9B, the material of the tool (for example, whether the tool is made from a metal, a ceramic material, or a composite) has a significant impact on the impedance determination. The impedance determination may, in general, be viewed as being based on passive characteristics.

In another embodiment, the tool is an endodontic file and a patient's tissue impedance (Zₚₐₜᵢₑₙₜ) is also determined and factored into the calculations to compute a file location for the file in a root canal procedure. Thus, this embodiment includes the first steps shown in FIG. 9B, followed by the steps of determining patient tissue impedance, and calculating a file location from the various impedance values.

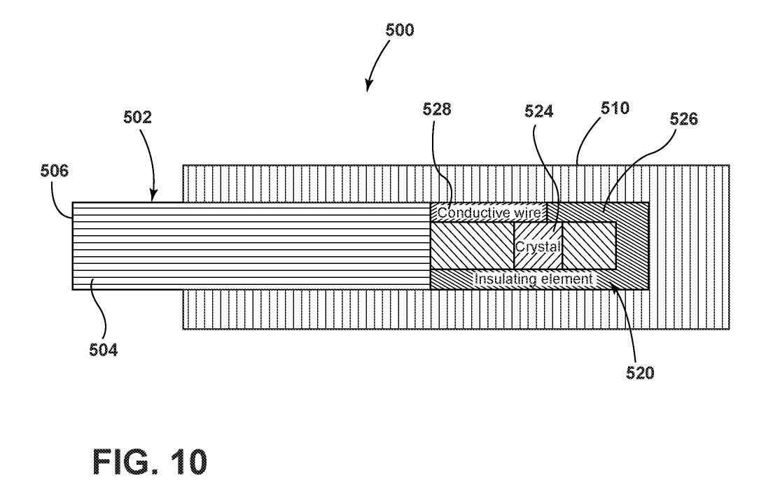

FIG. 10 shows an embodiment of a dental tool 500. In one embodiment, the dental tool 500 is an electronically-recognizable endodontic rotary file. In the embodiment of FIG. 5, the dental tool 500 includes a tool blank 502 that has at a distal end 504, for example, a cutting, a cleaning, or a drilling tip 506. At a proximal end of the tool blank 502, a tool handle 510 encases, preferably fixedly, the proximal tool blank end which includes a specialized and unique tool-identifying apparatus 520. The tool-identifying apparatus incorporates a crystal resonator 524. The crystal resonator 524 is configured to operate as a unique tool identifier. An insulating element 526 preferably surrounds the proximal file blank end except for a lateral window through which the crystal resonator 524 is in contact with a conductive wire 528 that transmits the unique tool identifier. In one embodiment, the dental tool 500 is a file that functions as an apex locator to measure the proximity of the file to the apical foramen of a root canal into which it is inserted during a root cancel procedure.

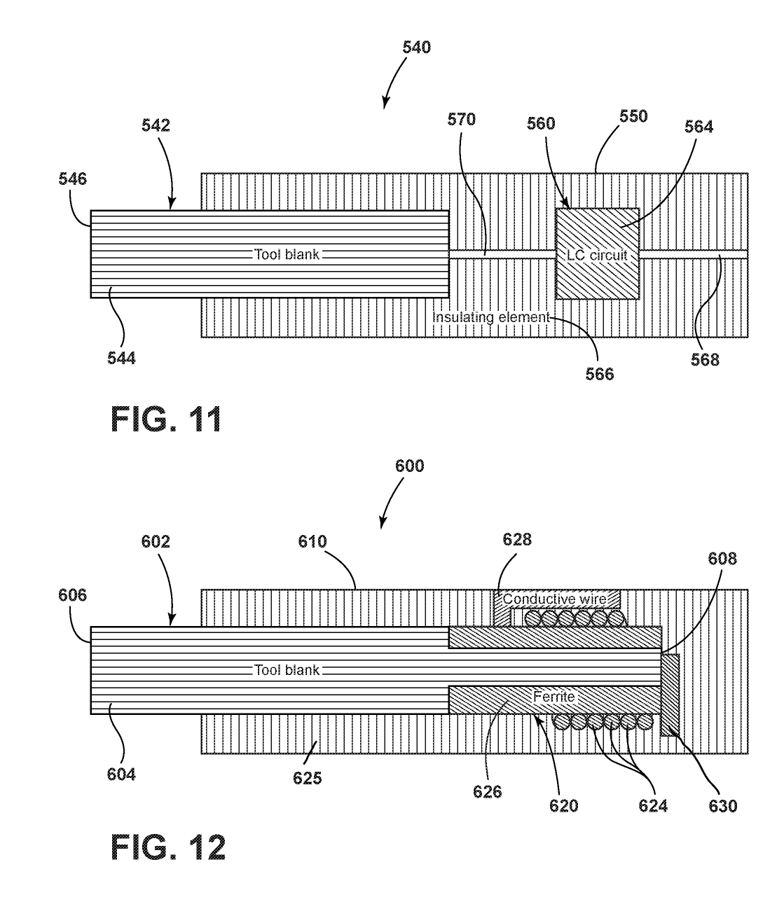

FIG. 11 shows an embodiment of an electronically-recognizable rotary dental tool 540. The tool 540 may include a tool blank 542 that may have at a distal end 544, e.g., a cutting, cleaning, or drilling tip 546. At a proximal end, a tool handle 550 may encase, preferably fixedly, the proximal tool blank end which includes a specialized and unique tool-identifying apparatus 560. The tool-identifying apparatus 560 incorporates an electrical resonator comprising an LC circuit 564 to provide a unique tool identifier. An insulating element 566 surrounds the proximal file blank end except for a proximal window through which the resonator is in contact with a conductive wire 568 that transmits the unique tool identifier through the tool handle 550 and handpiece to a processor. In some embodiments, the insulating element 566 is formed from all or part of the tool handle 550, for example, when the tool handle 550 is formed from a non-conductive material (for example, a polymeric material). In other embodiments, the insulating element 566 is formed from a non-conductive insert, for example, a polymeric plug inserted into the tool handle 550. The tool blank 542 may directly contact the LC circuit 564 or may be in contact with the LC circuit through a second conductive wire 570 through a distal window in the insulating element. In one embodiment, the tool 540 is a file that functions as an apex locator to measure the proximity of the file to the apical foramen of a root canal into which it is inserted.

The impedance of the LC circuit 564 may be used in the impedance determination discussed above with respect to FIG. 9B. In one example, the impedance of the LC circuit is added to the impedance of the tool. Since it is possible to vary components of the LC circuit and because some the components are active components, it is possible to create more impedance values. This, in turn, permits more precise determination of the tool type.

FIG. 12 shows an embodiment of an electronically-recognizable dental tool 600. The tool 600 includes a tool blank 602 that may have at a distal end 604, e.g., a cutting, cleaning, or drilling tip 606. At a proximal end 608, a handle 610 encases, preferably fixedly, the proximal file blank end which includes a specialized and unique tool-identifying apparatus 620. The tool-identifying apparatus 620 includes an electrical resonator comprising an LC or RLC circuit to provide a unique file identifier. An insulating element 625 surrounds the proximal file blank end except for a lateral window through which the resonator is in contact with a conductive wire that transmits the unique file identifier through the handle 610 and handpiece to a processor. The insulating element 625 may be formed and configured in a manner that is similar to the insulating element 566. The electrical resonator includes a conductive wire coil 624 surrounding one or more ferrite elements 626 that in turn surround the proximal end of the tool blank 602. The tool blank 602 may directly contact the LC or RLC circuit or may be in contact with the LC or RLC circuit through a conductive wire 628 through a distal window (not shown) in the insulating element. The tool blank 602 may also be in contact with a conductive element or wire 630. In one embodiment, the tool 600 is a file that functions as an apex locator to measure the proximity of the file to the apical foramen of a root canal into which it is inserted during an endodontic procedure.

The configuration shown in FIG. 12, including the conductive wire coil 624, may be viewed as acting like a transmission line transformer. This attribute may be used in calculations of impedance to provide a more precise determination of impedance values. This, in turn, permits more precise determination of the tool type.

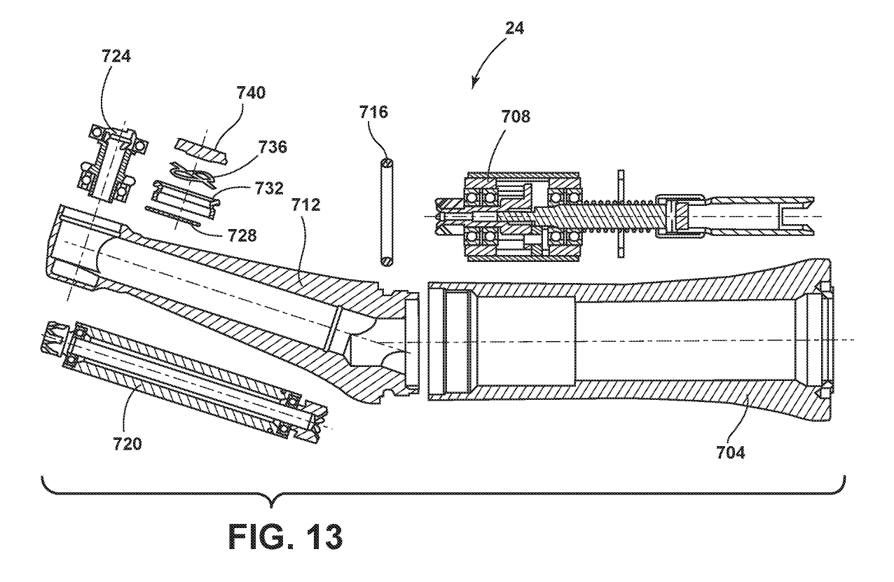

FIG. 13 shows a lateral cross-sectional exploded view of a contra-angle handpiece 24. The handpiece 24 includes a screw sleeve 704, a gearbox assembly 708, a spring washer, a head sleeve 712, an O-ring 7176, an intermediate piece assembly 720, a head gear assembly 724, a washer 728, a cover 732, a wave spring 736, and a button 740.

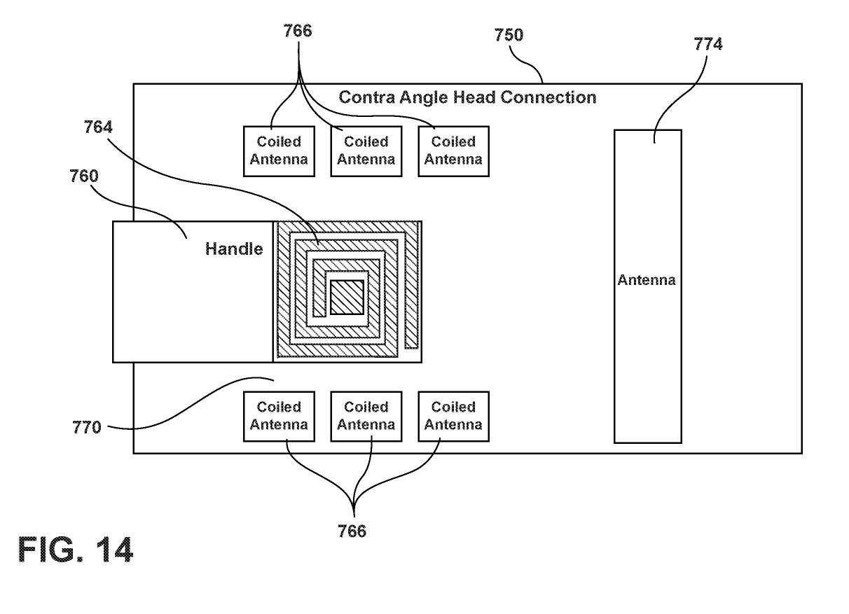

FIG. 14 is a schematic cross-sectional view of a contra-angle head connection 750 and a dental tool handle 760 that includes an appropriately-sized microchip 764. The microchip 764 is connected to an antenna boost 766 that is coiled around a PMMA-like block 770. FIG. 8C shows a similar structure. The block 770 is attached about the dental tool handle 760 to enable detection and/or processing of tool information by a dental tool-property sensing system. The contra-angle head connection 750 includes an antenna 774 to receive data from the microchip 764 for processing.

As mentioned previously, it should be understood that other embodiments may be utilized, and structural, functional and procedural modifications may be made without departing from the scope and spirit of the present invention.

Apparatuses and methods may involve some or all of the features of the illustrative apparatus and/or some or all of the steps of the illustrative methods. The steps of the methods may be performed in an order other than the order shown and described herein. Some embodiments may omit steps shown and described in connection with the illustrative methods. Some embodiments may include steps that are not shown and/or are not described in connection with the illustrative methods.

What is claimed is:

1. An electronically-recognizable surgical tool for insertion into a surgical handpiece for performing a surgical procedure, comprising:
a tool blank with a distal tip configured for performing the surgical procedure;
a proximal handle encasing a proximal end of the tool blank; and
a tool-identifying apparatus including a resonator embedded in the proximal end of the tool blank and providing a tool identifier.

2. The tool of claim 1, wherein the tool is inserted into a distal end of the handpiece.

3. The tool of claim 1, further comprising:
an insulating element encasing a portion of the proximal end of the tool blank; and a conductive wire in electrical contact with the resonator.

4. The tool of claim 1, wherein the conductive wire is configured to transmit the tool identifier from the resonator through the handpiece to a processor to identify the tool.

5. The tool of claim 3, wherein the tool identifier is transmitted after the tool is inserted into a distal end of the handpiece.

6. The tool of claim 5, wherein the resonator is a mechanical resonator that comprises a piezoelectric material.

7. An electronically-recognizable endodontic rotary tool for insertion into a dental handpiece for performing a dental procedure, comprising:
a tool blank with a distal tip configured for performing the dental procedure;
a proximal handle encasing a proximal end of the tool blank; and
a tool-identifying apparatus including:
an electrical resonator providing a tool identifier;
an insulating element encasing a portion of the proximal end of the tool blank; and
a conductive wire in electrical contact with the resonator.

8. A dental handpiece for performing a dental procedure comprising:
a housing;
a cylindrical rotary assembly within the housing and holding a tool handle therewithin;
a rotary assembly gear fixed to the rotary assembly on an external surface thereof and in mechanical contact with a drive gear;
one or more conductive slip rings secured to the rotary assembly on an external surface thereof;
one or more conductive brushes in contact with the one or more slip rings; and
one or more contacts at a proximal end of the tool handle for transmitting a specific tool identifier.

9. The dental handpiece of embodiment 8, further comprising one or more sensors, wherein the one or more brushes and the one or more contacts transmit data from the one or more sensors to a processor.

10. The dental handpiece of embodiment 9, wherein the one or more sensors comprise a sensor selected from a group consisting of: temperature sensors, velocity sensors, acceleration sensors, torque sensors, pressure sensors, load sensors, force sensors, optical sensors, conductivity sensors, location sensors and attitude sensors.

11. A dental tool handle for managing electronic information during a dental procedure comprising:
a cylindrical, hollow tool handle body with a proximal and a distal end;
an insulated wire extending within the tool handle body from the proximal end;
an electronic information manager comprising a printed circuit board attached to the distal end of the wire, a recess within the handle for receiving a file tip; and
a proximal conductive element for conducting electronic data from the wire to a processor,
wherein the handle features external contours complementary to internal contours of an assembly configured to engage the handle.

12. The tool of claim 11, wherein the information manager comprises a memory containing data corresponding to identity of the tool.

13. The tool of claim 11, wherein the information manager comprises a sensor tuned to an environmental parameter of the tool or the recess.

14. The tool of claim 11, wherein the information manager comprises an information-receiving element and an information-transmitting element.

15. The tool of claim 11, including
a sensor provided on the printed circuit board that is attached to the distal end of the wire and facing the recess within the handle for receiving the tool tip.

16. The file handle of claim 11, wherein an insulating lacquer prevents electrical conductivity between a conductive glue ball and the tool handle body.

17. A dental tool handle for collecting information during a dental procedure comprising:
an electrically insulating, proximal portion defining a first recess in a proximal end configured for receiving either a sensor or an information-managing chip; and
an electrically conductive distal portion defining a second recess in a distal end configured for receiving a proximal end of a tool tip.

18. The dental tool handle of claim 17, wherein a proximal end of the proximal portion features one or more external surface geometries configured for mechanical engagement with corresponding internal surface features of a rotary assembly.

19. The dental tool handle of claim 18, wherein the electrically insulating, proximal portion is embedded within the electrically conductive distal portion.

20. The dental tool handle of claim 18, wherein the
cylindrical body receives the information-managing chip that is electronically identifiable.

21. A dental tool handle for a dental procedure comprising:
a tool handle body receiving at a distal end a proximal end of a tool blank; and
at least one from a group consisting of: an electronic information-receiving device for receiving electronic information; an electronic information-storage device for storing electronic information; an electronic information-processing device for processing electronic information; an electronic information-transmitting device for transmitting information; and a tool identifying device for managing information.

22. An electronically-recognizable dental tool for attachment to a handpiece for performing a dental procedure, comprising:
a tool end configured for performing the dental procedure; and
a tool-identifying apparatus including at least one from a group consisting of: a resonator in the tool for providing a tool identifier and an analog mechanism for providing a tool identifier.

23. The dental tool of claim 22, wherein the
tool-identifying apparatus includes the resonator;
an insulating element encasing a portion of the tool; and
a conductive wire in electrical contact with the resonator,
wherein the conductive wire is configured to transmit the tool identifier from the resonator through the handpiece to a processor to identify the tool after the tool is inserted into an end of the handpiece.

24. The dental tool handle of claim 11, wherein the electronic information manager includes
a microchip provided with the printed circuit board facing the recess; and
the proximal conductive element including conductive glue for conducting the electronic data from the wire to the processor.

25. The dental tool handle of claim 24, wherein
the dental tool handle further including a conductive element extending within the tool handle body from the proximal end;
and
a conductive surface at the proximal end for conducting electronic data from the conductive element to a processor,
wherein the microchip is in electrical contact with a distal portion of the conductive element, the microchip disposed within a recess in the handle, the recess configured for receiving a tool tip.
